(19) United States
(12) Patent Application Publication
(10) Pub. No.: US 2004/0154176 A1
(43) Pub. Date: Aug. 12, 2004

(54) Apparatus for measuring angles

(76) Inventors: Tony Gaetano Montenegro, Gold Coast (AU); Annamaria Montenegro, Gold Coast (AU); Phillip Scott, Gold Coast (AU); Rodney Johnson, Gold Coast (AU)

Correspondence Address: SHOEMAKER AND MATTARE, LTD, 10 POST OFFICE ROAD - SUITE 110, SILVER SPRING, MD, 20910, US

(21) Appl. No.: 10/250,676

(22) PCT Filed: Jan. 16, 2002
(86) PCT No.: PCT/AU02/00039

(30) Foreign Application Priority Data
Jan. 16, 2001 (AU) 15010/01

(51) Int. Cl. B43L 7/10

(52) U.S. Cl. 33/471

(57) ABSTRACT

An apparatus (20) for measuring angles, typically a bevel square, having a first arm (27), a second arm (21) pivotally attached to the first arm, a transducer (62, 63) for detecting changes in the angular position of the second arm (21) relative to the first arm (27), a controller (66) communicating with the transducer (62, 63) for calculating an angular position value of the second arm (21) relative to the first arm (27) and an output device (67) communicating with the controller (66) which outputs the angular position value.

### TECHNICAL FIELD

The present invention relates generally to an apparatus for measuring angles and, in a particular aspect, to a bevel square capable of measuring and displaying angles.

The invention has been developed primarily for measuring angles and will be described hereinafter with reference to this application. However, it will be appreciated that the invention is not limited to this particular use.

### BACKGROUND ART

A bevel square is an apparatus that enables a user to mark lines at specific angles on a workpiece. A bevel square consists of a ruler or slide that is pivotally attached to a body. The ruler typically has a slot that is used in conjunction with a shaft to attach the ruler to the body. The shaft can slide along the slot so that the ruler can be translated as well as rotated relative to the body. The body typically has a slot in which the ruler or a portion of the ruler can be accommodated.

In order to mark a line at a desired angle on a workpiece using a bevel square the angle of the ruler relative to the body must first be adjusted. This is accomplished by using a protractor (or similar) to measure the angle of the ruler relative to the body as the position of the ruler is adjusted. Once the ruler is correctly positioned relative to the body the bevel square can be used to mark the line on the workpiece.

A bevel square can also be used in conjunction with a protractor to measure angles. This is accomplished by placing the bevel square on the workpiece containing the angle to be measured and adjusting the ruler relative to the body until the angle between the ruler and the body corresponds to the angle being measured. The protractor can then be used to measure the relative angle between the ruler and the body.

A problem with using a bevel square in the above described manner is that the bevel square must be used in conjunction with a protractor or similar device in order to measure the relative angle of the ruler and the body. This has the effect of complicating the tasks of drawing lines at specific angles on a workpiece and measuring angles contained in a workpiece. As a result of this additional complexity the time taken to perform the tasks is increased.

It is an object of the present invention to substantially overcome, or at least ameliorate, one or more of the deficiencies of the prior art.

### SUMMARY OF THE INVENTION

According to a first aspect of the present invention there is provided an apparatus for measuring angles, the apparatus having:

a first arm;

a second arm;

means pivotally connecting said second arm to said first arm;

a transducer for detecting changes in the angular position of the second arm relative to the first arm;

a controller communicating with the transducer, wherein the controller calculates an angular position value of the second arm relative to the first arm; and

an output device communicating with the controller, wherein the output device outputs the angular position value.

In a more particular form of the invention the apparatus is a bevel square in which the first arm is a body of the bevel square and the second arm is a ruler or slide of the bevel square.

Preferably, the connecting means comprises pivot means mounted for rotation relative to the first arm. Preferably the pivot means is rotatable with the second arm. Preferably, the second arm has an aperture that engages with the pivot means so that the second arm and the pivot means are rotationally locked together. Preferably, the pivot means is slidable longitudinally of the second arm. The aperture may be in the form of a slot so that the pivot means may slide longitudinally within the slot. The pivot means may include a pair of opposite substantially parallel sides which are spaced apart substantially the same distance as the width of the slot so as to be receivable in the slot for longitudinal slidable movement. Preferably, the first arm carries a shaft and the pivot means is mounted coaxially on the shaft for free rotation relative thereto. Suitably, the pivot means is in the form of a collar or bush mounted on the shaft.

The first arm preferably houses the transducer, the controller and the output device. An electrical power source for powering the controller, transducer and output device is preferably housed within the first arm.

Preferably, the transducer includes:

a sensor wheel that is driven by the pivot means; and

at least one sensor that can detect rotational movement of the sensor wheel.

Preferably, the sensor wheel includes a plurality of spokes which are uniformly positioned around the circumference of the sensor wheel. The sensor wheel may have 10 spokes uniformly positioned around its perimeter. The at least one sensor may output an electrical signal as each spoke passes the at least one sensor. The at least one sensor preferably has a light source and a light detector that can respectively transmit and receive infrared light. Preferably, the transducer has two sensors positioned adjacent each other.

Preferably, the pivot means drives the sensor wheel through a transmission gearing. The transmission gearing suitably comprises a series of intermeshing gears, suitably spur gears, the gears translating rotatable movement of the pivot means relative to the first arm into a multiplied rotational movement of the sensor wheel. Preferably, the gears are arranged longitudinally along the first arm between the pivot means and sensor wheel. The series of gears suitably include a gear mounted for rotation with the pivot means and a gear mounted for rotation with the sensor wheel.

In one preferred form, the transmission gearing may consist of:

a first gear coaxially mounted for rotational movement with the pivot means;

a second shaft;

a second gear coaxially mounted with the second shaft, wherein the second gear meshes with the first gear;

a third gear coaxially mounted with the second shaft and rotatable with the second gear;

a third shaft;

a fourth gear coaxially mounted with the third shaft, wherein the fourth gear meshes with the third gear;

a fourth shaft;

a fifth gear coaxially mounted with the fourth shaft, wherein the fifth gear meshes with the fourth gear;

a sixth gear coaxially mounted with the fourth shaft and rotatable with the fifth gear;

a fifth shaft;

a seventh gear coaxially mounted with the fifth shaft, wherein the seventh gear meshes with the sixth gear;

an eighth gear coaxially mounted with the fifth shaft and rotatable with the seventh gear;

a sixth shaft;

a ninth gear coaxially mounted with the sixth shaft, wherein the ninth gear meshes with the eighth gear;

a tenth gear coaxially mounted with the sixth shaft and rotatable with the ninth gear;

a seventh shaft, wherein the sensor wheel is coaxially mounted with the seventh shaft;

an eleventh gear coaxially mounted with the seventh shaft and wherein the eleventh gear meshes with the tenth gear, the sensor wheel being rotatable with the eleventh gear.

Preferably, the sensor wheel rotates 180 times for each rotation of the first shaft. Preferably, the gear ratio of the second gear to the first gear is 1:3. Preferably, the gear ratio of the fourth gear to the third gear is 1:2. Preferably, the gear ratio of the fifth gear to the fourth gear is 2:3. Preferably, the gear ratio of the seventh gear to the sixth gear is 1:4. Preferably, the gear ratio of the ninth gear to the eight gear is 1:2. Preferably, the gear ratio of the eleventh gear to the tenth gear is 1:2.5.

Whilst the above described one configuration of gear train between the pivot means and sensor wheel, it will be appreciated that the gear train may be in many different configurations.

The apparatus may include one or more adjustment knobs mounted for rotational movement with one gear for manually rotating the gear to effect through the transmission gearing pivotal adjustment of the first arm relative to the second arm.

A first adjustment knob may be coaxially mounted with and fixed to the fifth shaft, wherein the first adjustment knob can be used to rotate the fifth shaft and thus the sixth gear to effect “course” adjustment of the rotational position of the first arm relative to the second arm. A second adjustment knob may be coaxially mounted with and fixed to the seventh shaft, wherein the second adjustment knob can be used to rotate the seventh shaft and thus the eleventh gear to effect “fine” adjustment of the rotational position of the first arm relative to the second arm.

Preferably, the controller communicates with at least one button or switch. The at least one button or switch may be used to turn the output device on and off, change the format of the angular position value that is output by the output device or calibrate the apparatus. The controller may calculate the angular position value in degrees, radians or as a gradient. The controller may vary an angular position count depending on the output of the transducer. Preferably, the controller uses the angular position count to calculate the angular position value.

The output device is preferably a visual display such as a LCD (liquid crystal display).

In a further aspect, the present invention provides a bevel square having:

a main body;

a ruler or slide;

means pivotally connecting said ruler or slide to said body;

means for detecting the angular position or changes in angular position of the ruler or slide relative to said body; and

means associated with said detecting means for calculating and displaying said angular position.

Preferably, the detecting means includes pivot means rotatable with said ruler or slide, rotatable sensor means and gearing means between said pivot means and said sensor means for transmitting rotational movement of said pivot means into rotational movement of said sensor means.

### BRIEF DESCRIPTION OF THE DRAWINGS

In order that the invention may be more fully understood and put into practice, a preferred embodiment thereof will now be described with reference to the accompanying drawings in which

FIG. 1 is a schematic longitudinal sectional elevational view of a bevel square according to a first embodiment of the present invention;

FIG. 2 is a schematic plan view of the bevel square illustrated in FIG. 1;

FIG. 3 is a block diagram of the microprocessor and associated peripheral devices that are incorporated into the bevel square of FIG. 1; and

FIG. 4 is a flowchart that illustrates the operation of the bevel square illustrated in FIG. 1.

### DETAILED DESCRIPTION OF THE PREFERRED EMBODIMENT

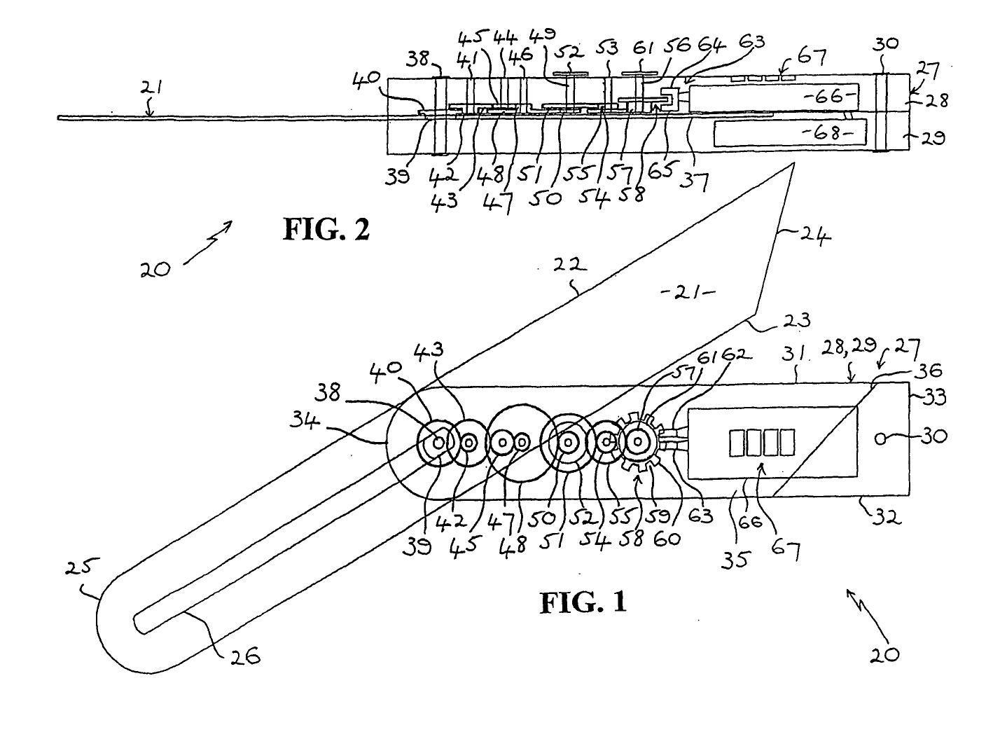

Referring firstly to FIGS. 1 and 2, there is illustrated a bevel square 20 according to a preferred form of the invention having a ruler or slide 21 pivotally attached to a body 27. Ruler 21 is substantially planar and has a generally elongated shape. Ruler 21 has two longitudinal sides 22, 23 that are parallel to each other. A first end 24 of the ruler 21 has a diagonal orientation relative to the sides 22, 23 while a second end 25 of the ruler 21 is rounded. The ruler 21 includes a slot 26 that is parallel to the sides 22, 23. The slot 26 extends approximately half the length of the ruler 21.

Members 28 and 29 (see FIG. 2) form the body 27 which is also elongated. Members 28, 29 are attached to each other by an attachment device 30. The attachment device 30 may be a screw or similar. The body 27 has a generally elongated shape and has two sides 31, 32 that are parallel to each other. The distance between the sides 31, 32 is the same as the distance between the sides 22, 23 of ruler 21. The body 27 has a flat first end 33 and a rounded second end 34. A region 35 between the members 28, 29 forms a slot 37 (see FIG. 2) that can accommodate a portion of the ruler 21. Slot 37 extends from a wall 36 to the rounded end 34 of body 27. Ruler 21 can be inserted into slot 37 so that end 24 of ruler 21 abuts against the wall 36.

A shaft 38 extends through and is fixed to the body 27. The shaft 38 also extends through a collar 39 which is coaxial with and free to rotate about shaft 38. The collar 39 extends through the slot 26 in the ruler 21. The collar 39 has a substantially parallel opposite sides which are spaced apart substantially the same distance as the width of the slot 26 so that the ruler 21 and the collar 39 are rotationally locked together however the collar 39 can slide or move along the length of slot 26 in the ruler 21. The shaft 38 may terminate in a threaded end for engagement with a thumb screw (not shown) as is conventional in bevel squares to enable the ruler or slide 21 to be locked in a particular position relative to the body 27 by tightening of the screw.

A gear 40 is fixed to collar 39 so that gear 40 can rotate in unison with collar 39. The gear 40 in this embodiment has 24 teeth extending around its perimeter.

With reference to FIG. 2 a shaft 41 is attached to member 28 of body 27 so that shaft 41 is free to rotate about its axis. Shaft 41 extends through and is fixed to a gear 42. Gear 42 has 8 teeth extending around its perimeter. Gear 42 meshes with gear 40 so that rotation of gear 42 causes gear 40 to rotate and vice versa. The gear ratio of gear 42 to gear 40 is 1:3. A gear 43 is mounted coaxially with and is fixed to gear 42 so that gear 43 and gear 42 can rotate in unison. Gear 43 has 24 teeth extending around its perimeter. Gear 43 does not engage with gear 40.

A shaft 44 is attached to member 28 of body 27 so that shaft 44 is free to rotate about its axis. Shaft 44 extends through and is fixed to a gear 45. Gear 45 has 12 teeth extending around its perimeter. Gear 45 meshes with gear 43 so that rotation of gear 45 causes gear 43 to rotate and vice versa. The gear ratio of gear 45 to gear 43 is 1:2.

A shaft 46 is attached to member 28 of body 27 so that shaft 46 is free to rotate about its axis. Shaft 46 extends through and is fixed to a gear 47. Gear 47 has 8 teeth extending around its perimeter. Gear 47 meshes with gear 45 so that rotation of gear 47 causes gear 45 to rotate and vice versa. The gear ratio of gear 47 to gear 45 is 2:3. A gear 48 is mounted coaxially with and is fixed to gear 47 so that gear 48 and gear 47 can rotate in unison. Gear 48 has 40 teeth extending around its perimeter. Gear 48 does not engage with gear 45.

A shaft 49 is attached to member 28 of body 27 so that shaft 49 is free to rotate about its axis. Shaft 49 extends through and is fixed to a gear 50. Gear 50 has 10 teeth extending around its perimeter. Gear 50 meshes with gear 48 so that rotation of gear 50 causes gear 48 to rotate and vice versa. The gear ratio of gear 50 to gear 48 is 1:4. A gear 51 is mounted coaxially with and is fixed to gear 50 so that gear 51 and gear 50 can rotate in unison. Gear 51 has 20 teeth extending around its perimeter. Gear 51 does not engage with gear 48.

An adjustment knob 52 may be fixed to the shaft 49. Adjustment knob 52 enables a user to manually rotate shaft 49 and thus the gear 50 and make coarse adjustments to the angular position of ruler 21 relative to body 27. By turning adjustment knob 52, 360 degrees ruler 21 is rotated by 10 degrees relative to the body 27. This is because the gear ratio between gear 50 and gear 40 is 1:36.

A shaft 53 is attached to member 28 of body 27 so that shaft 53 is free to rotate about its axis. Shaft 53 extends through and is fixed to a gear 54. Gear 54 has 10 teeth extending around its perimeter. Gear 54 meshes with gear 51 so that rotation of gear 54 causes gear 51 to rotate and vice versa. The gear ratio of gear 54 to gear 51 is 1:2. A gear 55 is mounted coaxially with and is fixed to gear 54 so that gear 55 and gear 54 can rotate in unison. Gear 55 has 30 teeth extending around its perimeter.

A shaft 56 is attached to member 28 of body 27 so that shaft 56 is free to rotate about its axis. Shaft 56 extends through and is fixed to a gear 57. Gear 57 has 12 teeth extending around its perimeter. Gear 57 meshes with gear 55 so that rotation of gear 57 causes gear 55 to rotate and vice versa. The gear ratio of gear 57 to gear 55 is 1:2.5. A sensor wheel 58 is mounted coaxially with and is fixed to gear 57 so that sensor wheel 58 and gear 57 can rotate in unison. Sensor wheel 58 has 10 spaces 59 and 10 radially extending spokes 60 extending around its circumference in an alternating manner.

An adjustment knob 61 may be fixed to the shaft 56. Adjustment knob 61 enables a user to manually rotate shaft 56 and thus gear 57 and make fine adjustments to the angular position of ruler 21 relative to body 27. By turning adjustment knob 61, 360 degrees ruler 21 is rotated by 2 degrees relative to body 27. This is because the gear ratio between gear 57 and gear 40 is 1:180.

As illustrated the respective gears are arranged longitudinally along the body 27 at spaced apart positions. The gears however may be arranged in other orientations and rations to transmit rotational movement of the ruler or slide 21 relative to the body 27 to rotational movement of the sensor wheel 58.

Sensors 62 and 63 are positioned adjacent to a peripheral region of sensor wheel 58. Sensors 62 and 63 each have a light source 64 positioned over one side of sensor wheel 58 and a corresponding light detector 65 positioned over an opposite side of sensor wheel 58. Each light source 64 continually emits infrared light towards a corresponding light detector 65. Each light detector 65 is able to detect infrared light. As sensor wheel 58 rotates spaces 59 and spokes 60 alternately pass between the light source 64 and light detector 65 of sensors 62 and 63. If a space 59 is positioned between the light source 64 and light detector 65 of either sensor 62 or 63 the infrared light emitted by the light source 64 is detected by the light detector 65 and the associated sensor 62 or 63 outputs an electrical signal that represents a logic 0. If a spoke 60 is positioned between the light source 64 and light detector 65 of either sensor 62 or 63 the infrared light emitted by the light source 64 is blocked by the spoke 60 so that the light detector 65 does not detect the infrared light. If the light detector 65 does not detect infrared light the associated sensor 62 or 63 outputs an electrical signal that represents a logic 1. Sensors 62 and 63 are positioned adjacent each other. The sensors 62, 63 are thus capable of detecting rotation and determining the direction of rotation.

The 10 spaces 59 and 10 spokes 60 of sensor wheel 58 result in sensors 62, 63 outputting a total of 20 pulses for each 360 degree rotation of sensor wheel 58. Therefore, for each 360 degree rotation of gear 40 (i.e. ruler 21 relative to body 27) sensors 62, 63 output a total of 36×5×200 3,600 pulses. This means that the maximum resolution of bevel square 20 is 0.1 degrees. Of course different resolutions may be obtained by varying the gearing ratios and/or varying the number of spaces 59 and spokes 60.

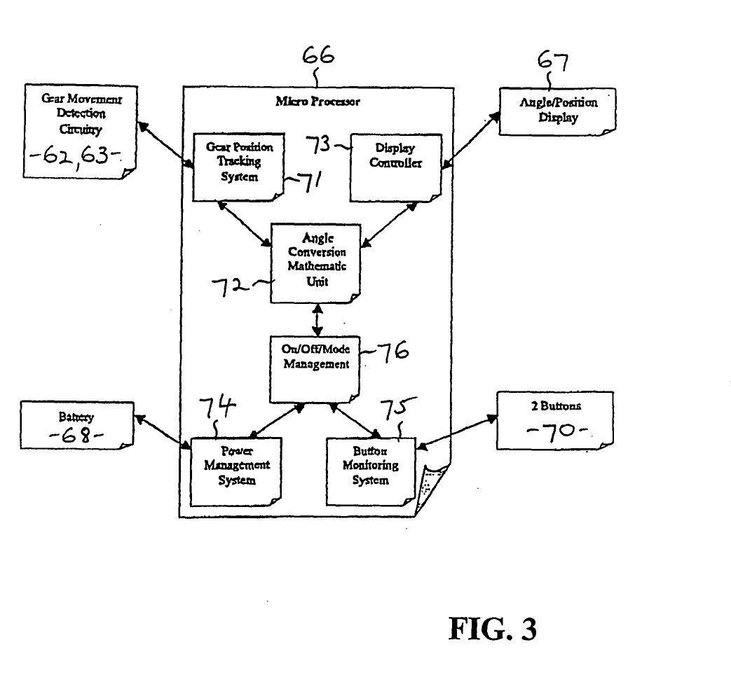

A microprocessor 66 is housed in member 28 of body 27. The output of sensors 62 and 63 are input to microprocessor 66 for processing. Microprocessor 66 controls a visual display unit 67 that is housed in member 28 of body 27. A pair of input buttons or switches 70 (see FIG. 3) are also mounted on body 27. Input buttons or switches 70 interface with microprocessor 66. A battery 68 provides electrical power to the electronic devices in bevel square 20.

With reference to FIG. 3 sensors 62, 63, visual display 67, battery 68 and input buttons or switches 70 interface with microprocessor 66. Microprocessor 66 includes a gear position tracking system 71, an angle conversion unit 72, a display controller 73, a power management system 74, a button or switch monitoring system 75 and an on off/mode management module 76. Gear position tracking system 71, angle conversion unit 72, display controller 73, power management system 74, button monitoring system 75 and on off/mode management module 76 are implemented in software that operates microprocessor 66 in an appropriate manner.

Gear position tracking system 71 processes the outputs of sensors 62, 63 and outputs the angular position of ruler 21 relative to body 27. Gear position tracking system 71 may, for example, output the angular position of ruler 21 relative to body 27 as an angular position count. A suitable algorithm is used by the gear position tracking system 71 to process the outputs of sensors 62, 63.

Angle conversion unit 72 processes the output (e.g. angular position count) of the gear tracking system 71 and outputs an angular position value of ruler 21 relative to body 27. The angular position value is output in a selected format such as degrees, radians or a gradient (e.g. millimetres per one thousand millimetres). On/off/mode management module 76 controls the format of the angular position value calculated by angle conversion unit 72. Display controller 73 receives the angular position value that is output by angle conversion unit 72 and controls visual display 67 to display the angular position value to a user.

Power management system 74 monitors and controls the power supplied by battery 68 to microprocessor 66. On/off/mode management module 76 controls power management system 74.

Button monitoring system 75 monitors the state of input buttons or switches 70. Button monitoring system 75 outputs the state of input buttons or switches 70 to on/off/mode management module 76. On/off/mode management module 76 uses the state of input buttons or switches 70 to control microprocessor 66.

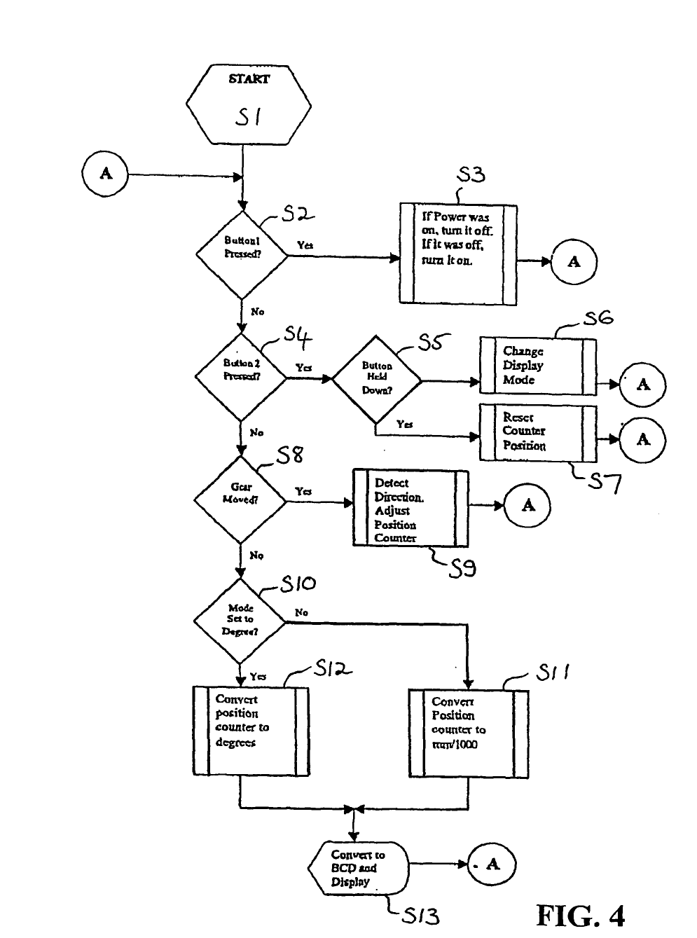

FIG. 4 is a flowchart that illustrates the operation of microprocessor 66. Microprocessor 66 operates in a continuous loop.

The flowchart commences at S1. At S1 the visual display 67 may be on so that the angular position value of ruler 21 relative to body 27 is displayed. Alternatively, the visual display 67 may be off so that the angular position value of ruler 21 relative to body 27 is not displayed.

At S2 microprocessor 66 determines whether a first button of input buttons 70 has been pressed since the previous cycle. If the first button has been pressed microprocessor 66 proceeds to S3. If the first button has not been pressed microprocessor 66 proceeds to S4.

At S3 microprocessor 66 switches the visual display 67 on if the visual display 67 is off. Alternatively, if the visual display 67 is on microprocessor 66 switches it off. After S3 microprocessor 66 loops back to A to start the processing cycle again.

At S4 microprocessor 66 determines whether a second button of input buttons 70 has been pressed since the previous cycle. If the second button has been pressed microprocessor 66 proceeds to S5. If the second button has not been pressed microprocessor 66 proceeds to S8.

At S5 microprocessor 66 determines whether the second button was held down. If the second button was not held down microprocessor 66 proceeds to S6. If the second button was held down microprocessor 66 proceeds to S7.

At S6 microprocessor 66 changes the display mode. For example, if the visual display 67 was displaying the angular position value in degrees microprocessor 66 may control the visual display 67 to display the angular position value as a gradient. As mentioned previously, the angular position value may also be displayed in radians. After S6 microprocessor 66 loops back to A to start the processing cycle again.

At S7 microprocessor 66 resets the angular position count of the gear position tracking system 71 to zero. This is done regardless of the actual angular position of ruler 21 relative to body 27. Thus, by holding the second button down a user is able to calibrate bevel square 20. After S7 microprocessor 66 loops back to A to start the processing cycle again.

At S8 microprocessor 66 determines whether sensor wheel 58 has moved since the previous cycle. If sensor wheel 58 has moved microprocessor 66 proceeds to S9. If sensor wheel 58 has not moved microprocessor 66 proceeds to S10.

At S9 microprocessor 66 determines the amount and the direction of movement of sensor wheel 58. The angular position count of gear position tracking system 71 is then appropriately adjusted. After S9 microprocessor 66 loops back to A to start the processing cycle again.

At S10 microprocessor 66 determines the current display mode of visual display 67. If visual display 67 is not displaying the angular position value in degrees microprocessor 66 proceeds to S11. If visual display 67 is displaying the angular position value in degrees microprocessor 66 proceeds to S12.

At S11 microprocessor 66 converts the angular position count of gear position tracking system 71 into an angular position value that is in the form of a gradient. Alternatively, microprocessor 66 may convert the angular position count into an angular position value that is measured in radians.

At S12 microprocessor 66 converts the angular position count of gear position tracking system 71 into an angular position value that is measured in degrees.

After S11 or S12 microprocessor 66 then proceeds to S13. At S13 the angular position value is converted to Binary Coded Decimal (BCD) format and is displayed on visual display 67. After S13 microprocessor 66 loops back to A to start the processing cycle again.

In order to set the angular position of ruler 21 relative to body 27 to a desired angular position adjustment knob 52 may be rotated in the appropriate direction until the actual angular position value displayed on visual display 67 approximates the desired angular position. Alternatively, ruler 21 may be rotated without using adjustment knob 52. In the later method of operation, a user merely grasps ruler 21 and manually rotates it relative to body 27. It can be appreciated that both of the aforementioned methods of operation enable coarse adjustments to be made to the angular position. In order to make fine adjustments to the angular position of 0.1 degrees or more adjustment knob 61 is rotated in the appropriate direction until the actual angular position displayed on visual display 67 is the same as the desired angular position. Fine position adjustment can also be achieved by manually rotating the ruler 21 relative to the body 27. Thus it is possible to provide the bevel square without adjustment knobs 52 and 61. In addition to setting the angular position of bevel square 20 to a desired angular position bevel square 20 can also be used to measure angles.

The foregoing describes only one embodiment of the present invention and modifications, obvious to those skilled in the art, can be made thereto without departing from the scope of the present invention.

1. An apparatus for measuring angles, the apparatus having:
a first arm;
a second arm;
means pivotally connecting said second arm to said first arm;
a transducer for detecting changes in the angular position of the second arm relative to the first arm;
a controller communicating with said transducer, wherein the controller calculates an angular position value of the second arm relative to the first arm; and
an output device communicating with the controller, wherein the output device outputs the angular position value.

2. The apparatus of claim 1, wherein said first arm comprises a body of a bevel square and said second arm comprises the ruler or slide of said bevel square.

3. The apparatus of claim 1 or 2, wherein said connecting means includes pivot means rotatable with said second arm and relative to said first arm, said transducer being responsive to rotatable movement of said pivot means relative to said first arm.

4. The apparatus of any one of claims 3, wherein the second arm has an aperture that engages with said pivot means so that the second arm and the pivot means are rotationally locked together.

5. The apparatus of claim 4 wherein said pivot means is slidable longitudinally relative to said second arm.

6. The apparatus of claim 5, wherein the aperture is in the form of a slot so that said pivot means may slide longitudinally within said slot.

7. The apparatus of claim 6 wherein said pivot means includes a pair of opposite substantially parallel sides, said sides being spaced apart substantially the same distance as the width of said slot so as to be receivable in said slot for longitudinal sliding movement.

8. The apparatus of any one of claims 3 to 7 wherein said first arm carries a shaft, said pivot means being mounted coaxially to said shaft for free rotation relative thereto.

9. The apparatus of any one of claims 1 to 8, wherein the first arm houses the transducer, the controller and the output device.

10. The apparatus of any one of claims 1 to 9, wherein the transducer includes:
a sensor wheel that is driven by said pivot means; and at least one sensor that can detect rotational movement of the sensor wheel.

11. The apparatus of claim 10, wherein said sensor wheel includes a plurality of spokes positioned uniformly around the circumference of said sensor wheel.

12. The apparatus of claim 10 or 11, wherein the at least one sensor outputs an electrical signal when a spoke passes the at least one sensor.

13. The apparatus of any one of claims 10 to 12, wherein the at least one sensor has:
a light source for transmitting light; and
a light detector for detecting light.

14. The apparatus of any one of claims 8 to 13, wherein there are two said sensors that are positioned adjacent to each other.

15. The apparatus of any one of claims 10 to 14, wherein said pivot means drives the sensor wheel through a transmission gearing.

16. The apparatus according to claim 15 wherein said transmission gearing includes a plurality of intermeshing gears, said gears translating rotational movement of said pivot means into multiplied rotational movement of said sensor wheel.

17. The apparatus of claim 16, wherein said gears of said transmission gearing are arranged longitudinally along said first arm.

18. The apparatus of claim 16 or claim 17 wherein said transmission gearing includes a gear mounted for rotational movement with said pivot means and a gear mounted for rotational movement with said sensor wheel.

19. The apparatus of claim 17 and including at least one adjustment knob mounted for rotational movement with one said gear for manually rotating said gear to effect through said transmission gearing pivotal adjustment of said first arm relative to said second arm.

20. The apparatus of any one of claims 1 to 19, wherein the controller communicates with at least one switch or button, said at least one switch being operable to turn the output device on and off, change the format of the angular position value that is output by the output device or calibrate the apparatus.

21. The apparatus of any one of claims 1 to 20, wherein the controller can calculate the angular position value in degrees, radians or as a gradient.

22. The apparatus of claim 21, wherein the controller uses the angular position count to calculate the angular position value.

23. The apparatus of any one of claims 1 to 22, wherein the output device is a visual display.

24. A bevel square having:
a main body;
a ruler or slide;
means pivotally connecting said ruler or slide to said body;
means for detecting the angular position or changes in angular position of the ruler or slide relative to said body; and
means associated with said detecting means for calculating and displaying said angular position.

25. A bevel square as claimed in claim 24 wherein said detecting means includes pivot means rotatable with said ruler or slide, rotatable sensor means and gearing means between said pivot means and said sensor means for transmitting rotational movement of said pivot means into rotational movement of said sensor means.
